(19) United States
(12) Patent Application Publication
(10) Pub. No.: US 2024/0081386 A1
(43) Pub. Date: Mar. 14, 2024

(54) Starch-Based Extruded Food Products and Methods for Manufacturing Starch-Based Extruded Food Products

(71) Applicant: PepsiCo, Inc., Purchase, NY (US)

(72) Inventors: Mathieu Larronde-Larretche, Seattle, WA (US); Ailsa Jayne Dalgliesh, Seattle, WA (US); Hsiu-Wu Guo, Seattle, WA (US); Michael Keoni Manion, Seattle, WA (US); Kathryn Grace Marston, The Colony, TX (US); Nebojsa Milanovich, Sammamish, WA (US); Deepali Palta, Dallas, TX (US); Bradley Scott Shepard, Wylie, TX (US); Melissa Marie Smith, Seattle, WA (US); Ross Chase Sundin, Frisco, TX (US); Maxwell Weil, Seattle, WA (US); Amanda Shinae Zila, Seattle, WA (US)

(21) Appl. No.: 17/768,207

(22) PCT Filed: Nov. 5, 2019
(86) PCT No.: PCT/US2019/059881

§ 371 Date: Apr. 11, 2022

(51) Int. Cl. A23P 30/20; A23L 5/10; A23L 7/13; A23L 19/18; A23P 20/10; A23P 20/18

(52) U.S. Cl. CPC A23P 30/20; A23L 5/11; A23L 7/13; A23L 19/19; A23P 20/11; A23P 20/18

(57) ABSTRACT

Starch-based extruded food products and methods for manufacturing starch-based extruded food products, such as snacks, are disclosed. For example, a starch-based dough may be extruded, cut, and cooked to form a starch-based extruded food product with a rigid extruded body. The cooking process may include baking and/or frying the cut extrusion. The rigid extruded body of the starch-based extruded food product is made up of bodies or segments coupled at joints. The rigid extruded bodies are configured such that bodies of the rigid extruded body may be broken off or separated at the joints to be consumed.

### BACKGROUND

Unless otherwise indicated herein, the materials described in this section are not prior art to the claims in this application and are not admitted as prior art by inclusion in this section.

Thin-sliced potato chips are a common snack food. Some products may have a uniform shape that is selected to allow stacking of the chips for packaging in a container. Some products require manufacturing steps tailored to accommodate the shape of the chips when stacking them and packaging them in containers.

### BRIEF SUMMARY

The present disclosure relates to food products, methods, and systems to manufacture food products. The food product may be, for example, starch-based snacks which may be formed, cooked, and packaged.

Food products and techniques for manufacturing food products are generally described relating to food processing and food items, such as snack foods. For example, the systems and methods described herein may be used to manufacture a food product that maintains its shape from production through to packaging, shipping and ultimately to the point of consumption. The shape may be chosen to minimize the amount of packaging required as well as maximize the snack density to packaging ratio. This can reduce packaging costs, increase the amount of product transported per load, and reduce damage to the food product while in transit.

Examples of described food products may include a starch-based extruded food product. The starch-based extruded food products may include a rigid extruded body made of a starch-based material, where the rigid extruded body may be made up of a plurality of bodies coupled at joints.

In some embodiments, the plurality of bodies may be segments or sections of the rigid extruded body. The food product may be configured such that one or more bodies from the plurality of bodies may be separated from or broken off of the rigid extruded body at joints. After breaking or separating the one or more bodies at joints, the one or more bodies become a separate rigid extruded body from the remainder of the rigid extruded body.

In some examples, the joints may be designated as the regions of the rigid extruded body where the pluralities of bodies meet, intersect, or otherwise touch. Both joints and bodies may define regions or portions of the rigid extruded body and thus may not be independent or separate entities during manufacture, as the rigid extruded body may be formed as a single piece.

In some examples, the starch-based extruded food products may have multiple bodies coupled at joints such that a body is disposed between two other bodies with joints designated at the intersection of the bodies. In some examples, a body is disposed at an oblique angle with respect to another body.

In some examples, multiple bodies may define a shape with an interior portion that defines an aperture and an exterior portion that is coupled to another of the bodies. In some embodiments, the shape may be a polygon or circle. The aperture may be an opening that extends along an interior surface through the rigid extruded body, and more specifically in the shape that is part of the rigid extruded body. The shape may be bounded on all sides and may be bounded by bodies and joints. The aperture may pass completely through the shape and may be open at either end. The rigid extruded body may have multiple shapes coupled to one another at joints on the exterior surface of the shapes. The shapes may be broken apart or separated at joints for consumption or use. Further, bodies may be broken off of or separated from a shape at joints.

In some examples, the plurality of bodies may include a base body with a top surface and a bottom surface and a fin body. Each fin body may extend from either the top or bottom surfaces of the corresponding base body. In some examples, fin bodies may be coupled to the surface from which they extend at a joint. In some examples, fin bodies may include an end that is coupled to joints of the corresponding base body. Various arrangements of fin bodies may extend from the top surface, the bottom surface, or from both the top and bottom surfaces of the base body. In some examples, the top surface and the bottom surface of the base body are opposite or opposing surfaces and are parallel or substantially parallel to one another.

In some additional examples, the described fin bodies extend from both the top and bottom surfaces of the base body such that the fin bodies extending from the top surface are substantially in coplanar alignment with the fin bodies extending from the bottom surface. In some other examples, the described fin bodies extend from the top and bottom surfaces of the base body such that the fin bodies extending from the top surface are substantially in offset non-coplanar alignment with the fin bodies extending from the bottom surface.

In some examples, a support body may be coupled to fin bodies at an offset from the top surface of the base body. In some additional examples, the support body may be coupled to the fin bodies at fin joints. In various embodiments, the support body may be parallel or substantially parallel to the base body. In some examples, the base body may be planar, curved, wavy, or sinusoidal along a longitudinal axis, when viewed along a horizontal axis.

In some examples the fin bodies may be disposed perpendicular to the top surface or the bottom surface of the base body.

In some examples, fin bodies extending from opposing surfaces, such as the top surface and the bottom surface, of the base body may be coupled to the base body at the same joint. In other words, a first fin body may extend from the top surface and a second fin body may extend from the bottom surface, and both the first fin body and the second fin body may be coupled to the base body at the same joint. In some examples two fin bodies may extend from the base body from one surface of the base body, while a third fin body may extend from the opposing surface of the base body, with the third fin body located between the first two fin bodies along a longitudinal axis. In other words, in some examples, a joint coupled to a fin body extending from the bottom surface may be located between two joints coupled to fin bodies extending from the top surface.

In some examples, the fin bodies may have a cross-sectional shape that, when viewed along a longitudinal axis, corresponds to a circle, a semi-circle, an ellipse, a semi-ellipse, or a polygon. In some examples, the cross-sectional shape may be a polygon that may be a triangle, a square, or a rectangle. In some examples, different fin bodies extending from different surfaces of the base body may have different cross-sectional shapes.

In some examples, the base body, when viewed along a vertical axis, may have at least two curved edges. In some examples, the curved edges may be rounded, curved, circular, semi-circular, elliptical, semi-elliptical, sinusoidal, or substantially sinusoidal. In some examples, the top surface and the bottom surface of the base body may be substantially planar. In some examples, the top surface and the bottom surface of the base body may be shaped such that they are substantially sinusoidal or curved along a longitudinal axis.

In some examples, fin bodies may be substantially perpendicular to the top surface of the base body. In some examples, fin bodies may be substantially perpendicular to the bottom surface of the base body.

In some examples, the rigid extruded body may be configured such that when a force is applied to a body, that body will break away or separate from the rigid extruded body at a joint. In some examples, a body may be disposed at an oblique angle with respect to at least another body.

In some examples, the rigid extruded body may be made up of bodies which define shapes having exterior surfaces and apertures through the shapes. In some examples, the bodies making up the shapes may be coupled together at a joint. In some examples, the shapes and bodies may be configured such that a force applied to a shape or a body will separate the shape or body from another shape or body at a joint. In some examples, a shape or body may be configured such that a force may be applied to a body that defines the shape to separate the body from the rest of the shape at one or more joints. In some examples, a first body defining a first shape may be coupled to a second body defining a second shape at a joint. In some examples, the first shape may have an exterior surface and an aperture through the first shape. In some examples, the second shape may have an exterior surface and an aperture through the second shape. In some examples, the first and second shapes may be the same shape or substantially the same shape.

Examples for methods of manufacturing the starch-based extruded food products discussed above and further described in the detailed description may include extruding a starch-based food mixture to form an extrusion, cutting the extrusion to form starch-based extruded food products and disposing the starch-based extruded food products in at least one cooking vessel to obtain cooked starch-based extruded food products.

In some examples, cooking the starch-based extruded food product may include disposing the starch-based extruded food product in an oven or a fryer. In some examples, water or oil may be applied to the starch-based extruded food product prior to disposing the starch-based extruded food product in a cooking vessel. In some examples, the applying the water or oil may further comprise spraying the water or oil with a sprayer.

In some examples, a starch-based extruded food product may be cooked or prepared by coating the starch-based extruded food products in oil prior to disposing them in at least one cooking vessel, disposing the starch-based extruded food products in a baking vessel, such as an oven, to bake the starch-based extruded food products, immersing the starch-based extruded food products in water or spraying the starch-based extruded food products with water, and then disposing the starch-based extruded food products in a fryer and frying them. In some examples, a starch-based extruded food product may be cooked or prepared by spraying the starch-based extruded food product in oil, baking it, spraying it with water, and then frying it.

In some examples, the starch-based extruded food product may be baked at a temperature in a range of between about 310 degrees Fahrenheit and 320 degrees Fahrenheit for a time in a range of about eighty-five to about ninety-five seconds.

In some examples, the starch-based extruded food product may be fried at a temperature in a range of between about 320 degrees Fahrenheit to about 330 degrees Fahrenheit for a time in a range of about two minutes to about three minutes.

In some examples, after the starch-based extruded food product is cooked, flavoring may be applied to or disposed on the exterior of the cooked starch-based extruded food product. In some examples, the flavoring may be a single ingredient, such as salt or pepper. In some examples, the flavoring may be a combination of ingredients such as salt and vinegar, sour cream and onion, or other flavorings.

In some examples, the cooked starch-based extruded food product may be packaged in form-fill packaging.

In some examples, the starch-based extruded food product may be disposed in a frame support prior to cooking or otherwise disposing the starch-based extruded food product in a cooking vessel. In some examples, the frame support may be part of a rail system or conveyor system. In some examples, the rail system or conveyor system may have engagement features that hold or engage the starch-based extruded food products as they are carried or transported through a cooking system.

Examples of systems may include a system for manufacturing starch-based extruded food products. In some examples, the system may include a dough mixer configured to combine and mix wet ingredients and dry ingredients into a starch-based food mixture. In some examples, the system may include an extruder feeder configured to provide the starch-based food mixture to an extruder configured to extrude the starch-based food mixture into an extrusion. In some examples, the system may include a cutter configured to cut the extrusion into starch-based extruded food products. In some examples, the system may include a rail system configured to transport the starch-based extruded food products into and through a cooking system, with a rail system end configured to deposit the starch-based extruded food products onto a conveyor system. In some examples, system may include a cooking system configured to cook the starch-based extruded food product. In some examples, the system may include a conveyor system configured to receive the starch-based extruded food product from the rail system after cooking.

In some examples, the system may include a packaging machine that is configured to package the starch-based extruded food products in packaging package. In some examples, the packaging machine may be fed by the conveyor system. In some examples, the packaging may be form-fill packaging.

In some examples, the cutter may cut the extrusion in more than one direction.

In some examples, the cooking system may comprise an oven for baking the starch-based extruded food products. In some examples, the cooking system may comprise a fryer for frying the starch-based extruded food products.

In some examples, the cooking system may comprise an oil sprayer configured to spray the starch-based extruded food products with oil, an oven configured to bake the starch-based extruded food products that have been sprayed with oil, a water sprayer configured to spray the starch-based extruded food products with water after baking, and a fryer configured to fry the starch-based extruded food products that have been sprayed with water.

The foregoing summary is illustrative only and is not intended to be in any way limiting. In addition to the illustrative aspects, embodiments, and features described above, further aspects, embodiments, and features will become apparent by reference to the drawings, the detailed description, and the claims.

### BRIEF DESCRIPTION OF THE DRAWINGS/FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings. The accompanying drawings, which are incorporated herein and form part of the specification, illustrate embodiments and, together with the description, further serve to explain the principles of the embodiments and to enable a person skilled in the relevant art(s) to make and use the embodiments. Embodiments will now be described, by way of example only, with reference to the accompanying schematic drawings, in which:

FIG. 1 is a perspective view of a starch-based extruded food product according to at least some embodiments.

FIG. 2 is a side view of the starch-based extruded food product of FIG. 1 according to at least some embodiments.

FIG. 3 is a side view of the starch-based extruded food product of FIG. 1 according to at least some embodiments.

FIG. 4 is a perspective view of the starch-based extruded food product according to at least some embodiments.

FIG. 5 is a side view of the starch-based extruded food product of FIG. 4 according to at least some embodiments.

FIG. 6 is a perspective view of the starch-based extruded food product according to at least some embodiments.

FIG. 7 is a side view of the starch-based extruded food product of FIG. 6 according to at least some embodiments.

FIG. 8 is a perspective view of the starch-based extruded food product according to at least some embodiments.

FIG. 9 is a perspective view of the starch-based extruded food product according to at least some embodiments.

FIG. 10 is a perspective view of the starch-based extruded food product according to at least some embodiments.

FIG. 11 is a perspective view of the starch-based extruded food product according to at least some embodiments.

FIG. 12 is a perspective view of the starch-based extruded food product according to at least some embodiments.

FIG. 13 is a side view of the starch-based extruded food product of FIG. 12 according to at least some embodiments.

FIG. 14 is a perspective view of the starch-based extruded food product according to at least some embodiments.

FIG. 15 is a side view of the starch-based extruded food product of FIG. 14 according to at least some embodiments.

FIG. 16 is a side view of the starch-based extruded food product according to at least some embodiments.

FIG. 17 is a flow chart of a method for producing a starch-based extruded food product according to at least some embodiments.

FIG. 18 is a flow chart of a method for producing a starch-based extruded food product according to at least some embodiments.

FIG. 19 is a schematic of a system for producing a starch-based extruded food product according to at least some embodiments.

FIG. 20 is a schematic of a system for producing a starch-based extruded food product according to at least some embodiments.

FIG. 21 is a schematic of a system for producing a starch-based extruded food product according to at least some embodiments.

The features and advantages of the present embodiments will become more apparent from the detailed description set forth below when taken in conjunction with the drawings, in which like reference numbers identify corresponding elements throughout. In the drawings, like reference numbers generally indicate identical, functionally similar, and/or structurally similar elements. Unless otherwise indicated, the drawings provided throughout the disclosure should not be interpreted as to-scale drawings.

### DETAILED DESCRIPTION

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus and/or system may be otherwise oriented (rotated 90 degrees or at other orientations) and the spatially relative descriptors used herein may likewise be interpreted accordingly.

The term “about” as used herein indicates the value of a given quantity that can vary based on a particular technology. Based on the particular technology, the term “about” can indicate a value of a given quantity that varies within, for example, 10-30% of the value (e.g., ±10%, ±20%, or ±30% of the value).

The term “substantially” as used herein indicates the value of a given quantity that can vary based on a particular technology. Based on the particular technology, the term “substantially” can indicate a value of a given quantity that varies within, for example, 0-10% of the value (e.g., ±1%, ±2%, or ±10% of the value).

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, may be arranged, substituted, combined, separated, and designed in a wide variety of different configurations, all of which are implicitly contemplated herein.

Techniques are generally described that include methods, systems, products, devices, and/or apparatuses related to starch-based extruded food products and related methods and systems for producing starch-based extruded food products. For example, a starch-based extruded food product may be produced by extruding a starch-based food product shape from a starch-based dough or food mixture and then cooking the extrusion. In some embodiments, the starch-based extruded food product is configured to be more cost efficient for manufacturing, packaging, and/or shipping, according to embodiments as described herein. In some examples, the starch-based extruded food products may be configured to require less manipulation in manufacturing. In some examples, the starch-based extruded food products may be configured to require less air volume in packaging. In some examples, the starch-based extruded food products may be configured to fit in form-fill packaging. In some examples, the starch-based extruded food products may be configured to be stacked efficiently when shipped. In some examples, the starch-based extruded food products may be configured to be more resilient to breaking during transport or shipping.

In at least one embodiment, the starch-based extruded food products correspond to starch-based extrusion that forms a rigid extruded body made up of bodies coupled at joints. In various embodiments, each of the bodies can be individual segments or made up of multiple segments. The shape of the rigid extruded body and the bodies or segments, as well as the orientation of the bodies relative to one another at the joints, are arranged such that a force can be applied to the rigid extruded body about one of the bodies to break that body away from the rigid extruded body and other bodies. In some embodiments, a break may occur at a joint where the body is coupled to another body of the rigid extruded body. Once broken away, the body may be consumed by a user and the process may be repeated until a single body remains, which may then be consumed.

The starch-based extruded food products may be made up of a starch-based dough that can be extruded. In some embodiments, the starch-based dough is made up of a combination of one or more starch ingredients, including, for example, rice flour, wheat flour, gluten, and potato flakes. These ingredients may be combined to form the starch-based dough, which can be extruded, cut to size and/or shape, and cooked.

The starch-based extruded food products may be cooked using a variety of cooking methods and techniques, or combinations thereof, including, for example, baking, boiling, broiling, grilling, poaching, steaming, freeze-drying, microwaving, and frying. The cooking process may further include processing steps such as the application of additional ingredients, including water, oil, and flavoring, to the starch-based extruded food products. In some embodiments, the flavoring may be a single ingredient, such as salt or pepper. In some embodiments, the flavoring may be a combination of ingredients such as salt and vinegar flavoring, sour cream and onion flavoring, or other flavorings. Further detail on the method of preparing and cooking the starch-based extruded food products is provided in the descriptions of the method figures below.

Once cooked, the starch-based extruded food products may be packaged, for example, in a form-fill package that can reduce manufacturing cost and shipping volume. Further, in some embodiments, the rigid extruded body of the starch-based extruded food products and/or the packaging provides sufficient structural support that the food product is resistant to shipping damage. In other embodiments, the rigid extruded body of the starch-based extruded food products may be configured to reduce the amount of excess packaging volume required when packaging the starch-based extruded food products.

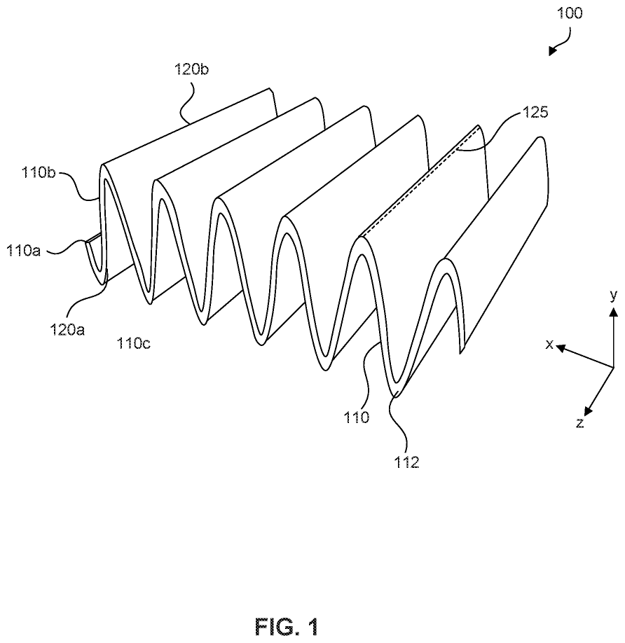

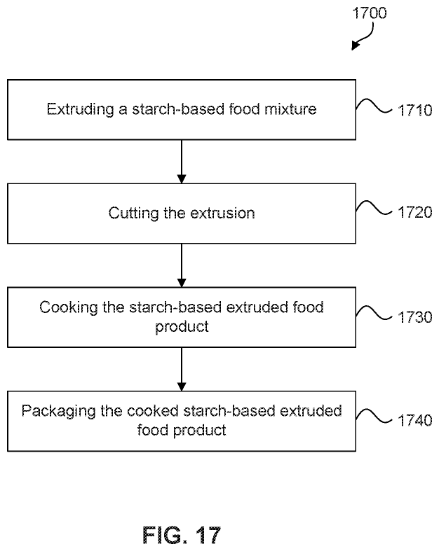

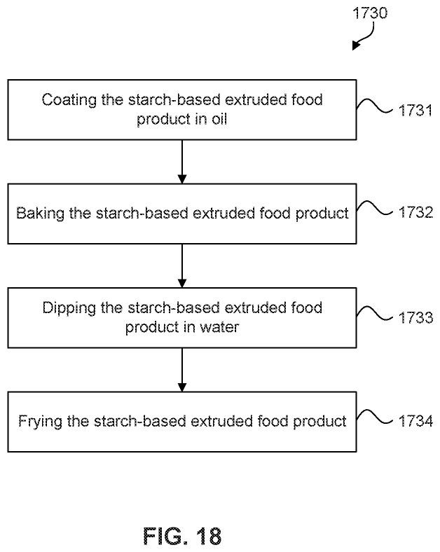

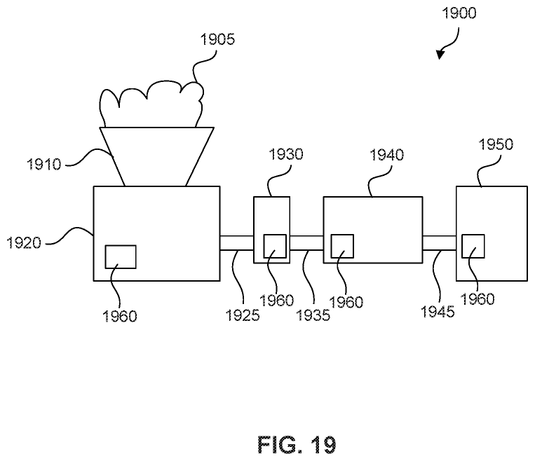

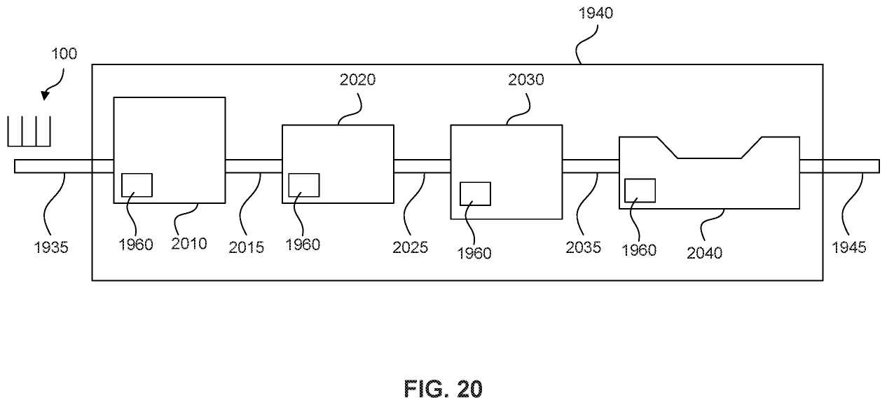

FIGS. 1 to 16 depict various illustrations and views according to embodiments of starch-based extruded food products. Those skilled in the art will understand that the description provided below describes a number of features that may be combined or modified to create various embodiments, including embodiments not explicitly depicted. The starch-based extruded food products as discussed may be uncooked in some embodiments and cooked in other embodiments. Some embodiments of methods to cook the starch-based extruded food products are described in FIGS. 17 and 18 and the accompanying detailed description below. Examples of systems configured to perform various described methods may be found in FIGS. 19 and 20 and the accompanying detailed description below.

Throughout FIGS. 1-16, axes are defined. In three-dimensional representations, the x-axis is a longitudinal axis, the y axis is a vertical axis, and the z-axis is a horizontal axis. In two-dimensional figures, the z-axis is in and out of the page and only the x and y axes are shown. Where the two-dimensional figures correspond to a three-dimensional figure, such as when a side view is shown, the x and y axes should be considered the same reference axes in both figures.

FIG. 1 illustrates a starch-based extruded food product 100 according to at least some embodiments. The starch-based extruded food product 100 is a rigid extruded body which is formed as a single piece. The rigid extruded body is made up of a plurality of bodies 110 (such as 110a, 110b, and 110c) which are coupled at respective joints 120. The starch-based extruded food product 100 may be made up of any number of bodies 110 coupled at any number of joints 120 (such as 120a and 120b).

In some embodiments, each body 110 has an edge 112 which runs the length of the body 110 in the horizontal axis. The joints 120 are the intersection of two edges 112 where a first body 110 meets a second body 110, such as where body 110a meets and is coupled to body 110b at joint 120a.

In some embodiments, bodies 110 form angles with respect to one another. In some embodiments, each of the bodies 110 form oblique angles with respect to one another.

In an embodiment, a body 110a is coupled to a body 110b at joint 120a, and body 110b is further coupled to a body 110c at joint 120b, and so forth. Joint 120a is the intersection of body 110a and body 110b along the horizontal axis, while joint 120b is the intersection of body 110b and body 110c along the horizontal axis.

As discussed above and further below, bodies 110 may be broken or separated from the rigid extruded body of the starch-based extruded food product 100 by applying force to break or separate the rigid extruded body about the joints 120. For example, force may be applied to body 110a, which breaks or separates from the starch-based extruded food product 100 at joint 120a. Body 110b may be further broken from the starch-based extruded food product 100 at joint 120b by a second application of force. The bodies may be eaten after being broken off or separated.

In some embodiments, multiple bodies 110 of the starch-based extruded food product 100 may be broken apart or separated, such as by applying force to bodies 110a and 110b such that they break away or separate from the starch-based extruded food product 100 at joint 120b. In some embodiments, bodies 110a and 110b may be further broken apart or separated by applying force to break them apart or separate them at joint 120a. The bodies may be eaten after being separated. In some embodiments, bodies 110a and 110b may be eaten together without separating them.

In some embodiments, the joints 120 of starch-based extruded food product 100 may be configured to break more easily. For example, in some embodiments, the joints 120 may be thinner than the surrounding bodies 110 of the starch-based extruded food product 100. In some embodiments, the joints 120 may be raked, cut, perforated, or the like, for example, after extrusion to allow the bodies 110 to be more easily be broken apart at the joints 120. For example, in some embodiments, perforations 125 may be present along one or both sides of a joint 120. Similar features to those described above and as illustrated in FIG. 1 may be part of any of the embodiments at some or all of their respective joint elements, as described above, below, and in the figures.

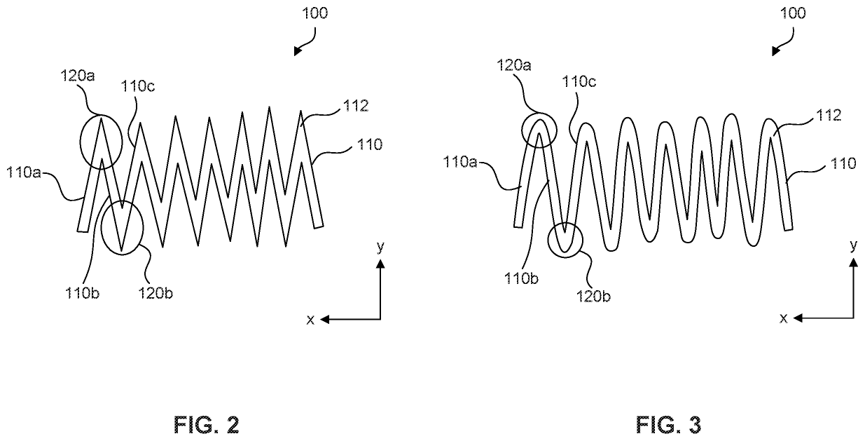

FIG. 2 is a side view of a starch-based extruded food product, such as starch-based extruded food product 100 depicted in FIG. 1 according to at least some embodiments. As discussed above, the starch-based extruded food product 100 is a rigid extruded body made up of bodies 110 coupled at joints 120, such as bodies 110a, 110b, and 110c, coupled at joints 120a and 120b. In some embodiments, each of the individual bodies 110a, 110b, and 110c, for example, may be the same length. In some embodiments, each of the individual bodies 110a, 110b, and 110c may be substantially different in length. Example joints 120 are more particularly indicated as illustrated with regards to FIG. 1 and as indicated by the circles at the end of the lead lines in the figure. As shown, the joints 120 represent areas or regions where two or more bodies come together.

Some embodiments, such as the one depicted in FIG. 2, have bodies 110 configured such that the surfaces of the bodies meet at an edge of the joint, as seen where bodies 110a and 110b meet and form a sharp edge at joint 120a as viewed in the x-y plane.

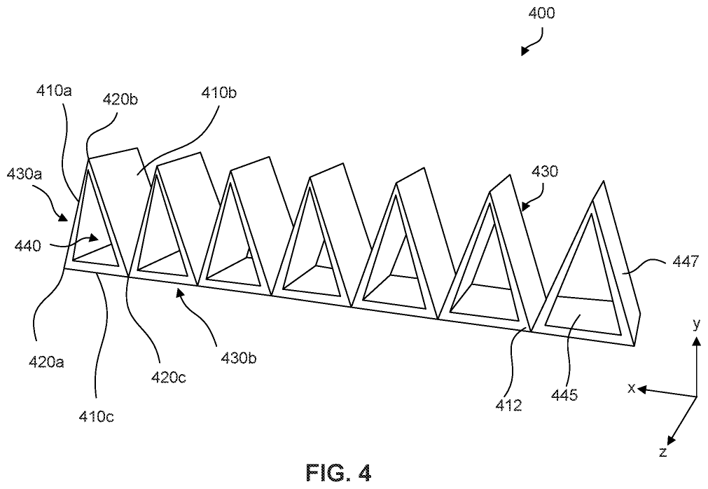

FIG. 3 is a side view of a starch-based extruded food product, such as starch-based extruded food product 100 depicted in FIG. 1 according to at least some embodiments. Again, the starch-based extruded food product 100 is a rigid extruded body made up of bodies 110 coupled at joints 120, such as bodies 110a, 110b, and 110c, coupled at joints 120a and 120b. The joints 120 are more particularly indicated as described above with regards to FIG. 1 and as indicated by the circles at the end of the lead lines in the figure.

Some embodiments, such as the one depicted in FIG. 3, have bodies 110 configured such that the surfaces of the bodies are rounded where they meet at the joint, as seen where bodies 110a and 110b meet and their surfaces curve and couple at joint 120a as viewed in the x-y plane.

FIG. 4 illustrates starch-based extruded food products 400 according to some embodiments. In these illustrated embodiments, the starch-based extruded food product 400 is a rigid extruded body. The starch-based extruded food product 400 is made of bodies 410 (such as bodies 410a, 410b, and 410c) coupled at joints 420 (such as 420a, 420b, and 420c). In some embodiments, the bodies 410 form shapes 430. A shape 430 in this context may be defined by one or more bodies 410 coupled at one or more joint(s) 420, which may form an aperture 440 through the shape 430.

In some embodiments, one single body may form a shape (e.g., a circle, an oval, an ellipse, etc.). In some additional embodiments, two or more bodies may be coupled together at joints 420 to form a shape 430. Such joints 420, such as joint 420c, are where the edge 412 of a first shape 430 meets the edge 412 of a second shape 430. In some examples, three or more bodies 410 may be coupled together at joints 420 to form a shape 430. Shapes 430 may be coupled to one another at a joint 420 along an exterior surface 447 of the shape. As illustrated, the joints 420 may be the intersection of bodies 410 or shapes 430 along the horizontal edges, such as edge 412. The bodies 410 may be arranged and coupled by joints 420 so as to form an aperture 440 through an interior portion of the shape 430. In some embodiments, the interior portion of aperture 440 may be an interior surface 445. For example, the bodies 410 and joints 420 may be arranged such that the bodies 410 collectively outline a cross-sectional shape 430 as observed in one plane or a set of axes (e.g., the x-y plane), while the interior surface 445 of the outlined shape define an aperture 440 through the shape 430 that extends through the shape along another axis or direction (e.g., the z-axis).

For example, bodies 410a, 410b, and 410c are coupled at joints 420a, 420b, and 420c to form shape 430a. The bodies 410a, 410b, and 410c along with joints 420a, 420b, and 420c form an opening through the shape 430a along the axis direction that corresponds to the aperture 440, for example, in the z-direction shown in FIG. 4.

Shape 430a may be coupled to shape 430b at joint 420c on the exterior surface 447 of both shape 430a and shape 430b. In some embodiments, shape 430a can be broken off or otherwise separated from shape 430b and the starch-based extruded food product 100 by applying sufficient force to shape 430a such that shape 430a separates from the starch-based extruded food product 100 at joint 420c. In some examples, shape 430b may then be consumed.

In other embodiments, after breaking or separating a shape 430 from the starch-based extruded food product 400, bodies 410 can be broken or separated from a shape 430 at joints 420 by application of force. In some embodiments, bodies 410 can be consumed after being broken off of or separated from the shape 430.

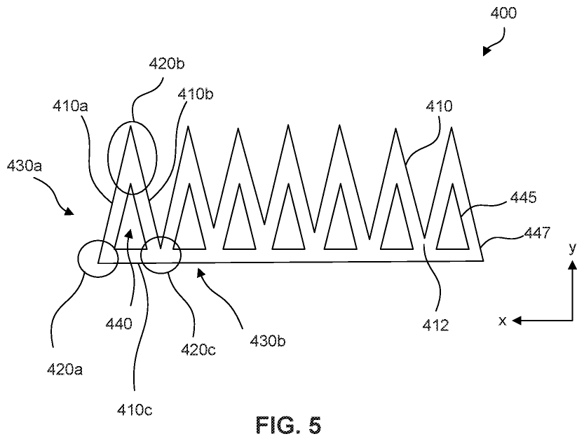

FIG. 5 is a side view of a starch-based extruded food product such as starch-based extruded food product 400 depicted in FIG. 4 according to at least some embodiments. As discussed above, the starch-based extruded food product 400 is a rigid extruded body made up of bodies 410 coupled at joints 420, such as bodies 410a, 410b, and 410c, coupled at joints 420a, 420b, and 420c to form shapes 430. Bodies 410 have edges 412. The bodies 410 and joints 420 are arranged to form an aperture 440 through the interior of the shape 430. The shapes 430 have interior surface 445 and exterior surface 447. Shapes 430 are coupled at joints 420 on the exterior of the shape 430, such as shape 430a coupled to shape 430b at joint 420c. The joints 420, surfaces, and apertures 440 are more particularly indicated as described above with regards to FIG. 4 and as indicated by the circles at the end of the lead lines in the figure. As shown, the joints 420 represent areas or regions where two or more bodies come together.

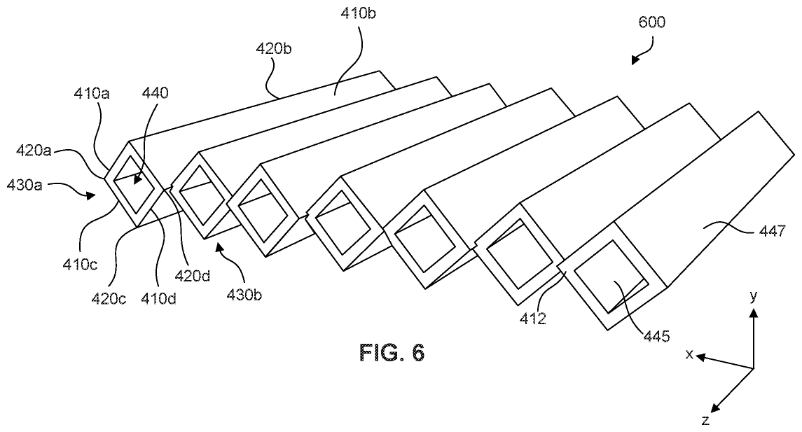

FIG. 6 illustrates a starch-based extruded food product 600 according to at least another embodiment. Such embodiments may be similar to the embodiment in FIG. 4 and FIG. 5 in that they are made up of shapes 430 formed by bodies 410 coupled at joints 420. However, embodiments according to FIG. 6 may be made up of four bodies 410 (such as bodies 410a, 410b, 410c, and 410d) coupled at four joints 420 (such as joints 420a, 420b, 420c, and 420d). In some embodiments according to FIG. 6, shape 430a is formed from bodies 410a, 410b, 410c, and 410d, coupled at joints 420a, 420b, 420c, and 420d which are the intersection of the bodies 410 along the edges 412 of the bodies 410. The bodies 410 and joints 420 may be arranged such that shape 430a has an aperture 440 that is an opening through the interior of shape 430a along the horizontal direction. Shape 430 may have an interior surface 445. Shape 430a may be coupled to shape 430b at joint 420d, which is the intersection of shapes 430a and 430b along the edge 412. In some embodiments, shape 430 may have an exterior surface 447.

Some embodiments of the starch-based extruded food product 600 containing shapes 430, may be broken apart and consumed in a similar manner to that described above for FIG. 4. Those skilled in the art will appreciate that the embodiments in FIG. 4 and FIG. 6 are not meant to be limiting on the exact configuration of a starch-based extruded food product 400 or 600 and that embodiments may be formed with any desired number of bodies 410 and corresponding joints 420, such as any configuration with a single body 410 forming a shape 430 that is a circle with an interior aperture 440 through the shape 430 and an exterior surface 447 coupled to other shapes 430 at a joint 420 on its exterior surface 447, as well as a configuration of any number of bodies 410 coupled at joints 420 to form shapes 430 with apertures 440 through the shape 430 and joints 420 at the exterior surface 447 joining the shapes 430 together. In some embodiments, there are five or more bodies 410 that make up a shape 430. In some embodiments, the shape 430 is a polygon. In some embodiments, different shapes 430 may be part of the same starch-based extruded food product.

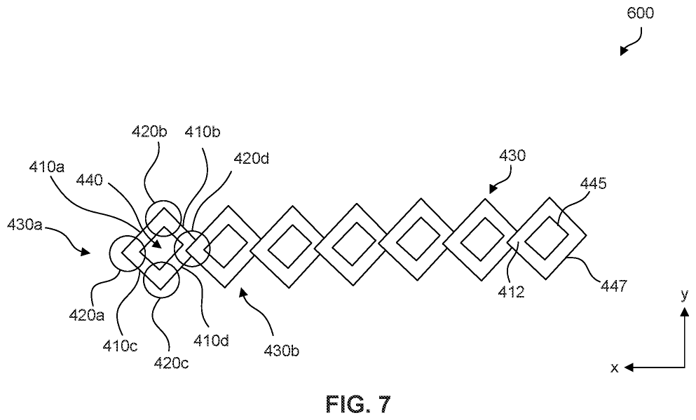

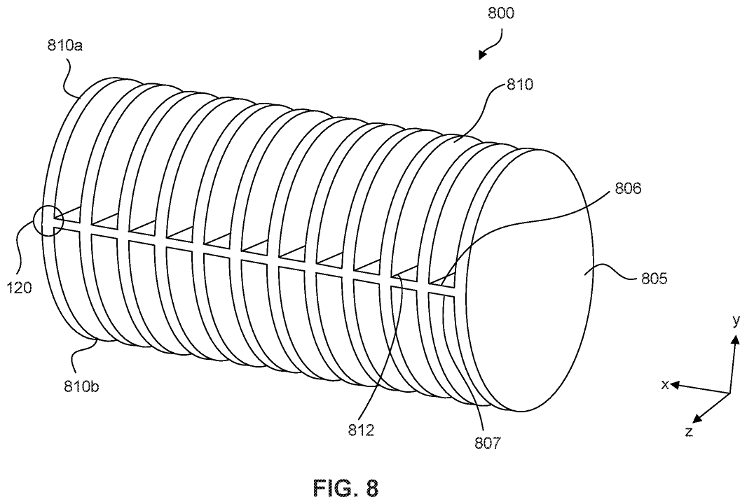

FIG. 7 is a side view of a starch-based extruded food product such as starch-based food product 600 depicted in FIG. 6 according to at least some embodiments. As discussed above, the starch-based extruded food product 600 is a rigid extruded body made up of bodies 410 coupled at joints 420, such as bodies 410a, 410b, 410c, and 410d, coupled at joints 420a, 420b, 420c, and 420d to form shapes 430a and 430b. Shapes 430 have interior surfaces 445 and exterior surfaces 447. Bodies 410 have edges 412. The bodies 410 and joints 420 may be arranged to form an aperture 440 through the interior of shape 430. Shapes 430 may be coupled at joints 420 on the exterior surface 447 of the shape 430, such as shape 430a coupled to shape 430b at joint 420d. The joints 420 are more particularly indicated as described above with regards to FIG. 6 and as indicated by the circles at the end of the lead lines in the figure. As shown, the joints 420 may represent areas or regions where two or more bodies 410 come together at edges 412.

FIG. 8 illustrates a starch-based extruded food product 800 according to at least some embodiments. As shown in FIG. 8, for example, the starch-based extruded food product 800 may be a rigid extruded body made up of a base bodies 805 and fin bodies 810 (such as fin bodies 810a and 810b) which are coupled at joints 120. Fin bodies 810 may have edges 812. Joints 120 may be the intersection of edges 812 with the base body 805 or other fin bodies 810. The joints 120 are more particularly indicated by the circles depicted at the end of the lead lines in the figure. As shown, the joints 120 represent areas or regions where two or more bodies come together. The fin bodies 810 may extend from the top surface 806 and the bottom surface 807 of the base body 805. The base body 805 runs the length of the starch-based extruded food product 100 in the longitudinal axis (e.g., x-axis). The top surface 806 and bottom surface 807 are opposing sides of the base body 805 that are in the x-z plane. In some embodiments, the fins 810 extend from the edge 812 that is coupled to the base body 805 at a joint 120.

In the embodiments depicted in FIG. 8, fin body 810a and similar fin bodies 810 extend from the top surface 806 of base body 805, and fin body 810b and similar fin bodies 810 extend from the bottom surface 807 of base body 805. In some embodiments, fin bodies 810 extending from different surfaces, such as top surface 806 and bottom surface 807, extend from and are coupled to each other and base body 805 at a common joint 120. For example, fin body 810a and fin body 810b are coupled to each other and base body 805 at joint 120. In some embodiments, as shown for example in FIG. 8, fin bodies 810 may be semi-circular in shape as viewed down the x-axis. In some additional embodiments, the fin bodies 810 extending from the top surface 806 may be substantially coplanar with the fin bodies extending from the bottom surface 807. In some other embodiments, the fin bodies 810 extending from the top surface 807 may be substantially in offset non-coplanar alignment with the fin bodies 810 extending from the bottom surface 807.

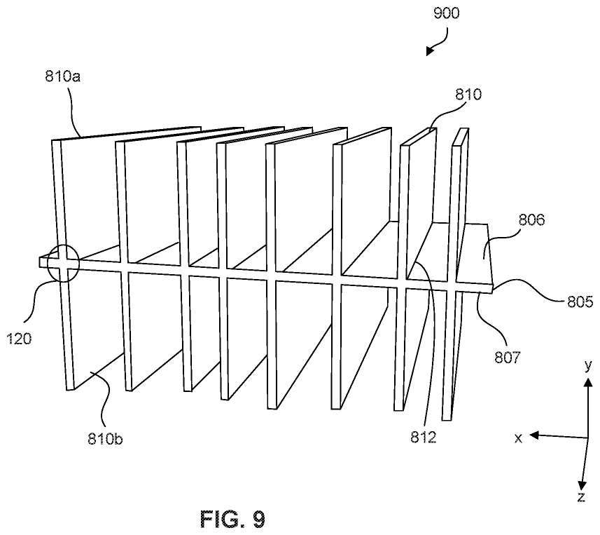

FIG. 9 illustrates a starch-based extruded food product 900 according to additional embodiments. Similar to the embodiment in FIG. 8, the embodiment in FIG. 9 is a rigid extruded body made up of a base body 805 and fin bodies 810 (such as 810a and 810b) which are coupled at joints 120 Fin bodies 810 may have edges 812. Joints 120 may be the intersection of edges 812 with the base body 805 or other fin bodies 810. The joints 120 are more particularly indicated by the circles depicted at the end of the lead lines in the figure. As shown, the joints 120 represent areas or regions where two or more bodies come together. The fin bodies 810 may extend from the top surface 806 and bottom surface 807 of the base body 805. The base body 805 runs the length of the starch-based extruded food product 100 in the longitudinal axis. The top surface 806 and bottom surface 807 are opposing sides of the base body 805 that are in the x-z plane. In some embodiments, as shown for example in FIG. 9, fin bodies 810 may be rectangular in shape as viewed down the x-axis. In some embodiments, the fins 810 may extend from the edge 812 that is coupled to the base body 805 at a joint 120. In some additional embodiments, the fin bodies 810 extending from the top surface 806 may be substantially coplanar with the fin bodies extending from the bottom surface 807. In some other embodiments, the fin bodies 810 extending from the top surface 807 may be substantially in offset non-coplanar alignment with the fin bodies 810 extending from the bottom surface 807.

In some embodiments, the joints 120 where fin bodies 810 couple to the base body 805 may be evenly spaced on the base body 805 along the longitudinal axis. In some other embodiments, the joints 120 where fin bodies 810 couple to the base body 805 may be un-evenly spaced on the base body 805 along the longitudinal axis.

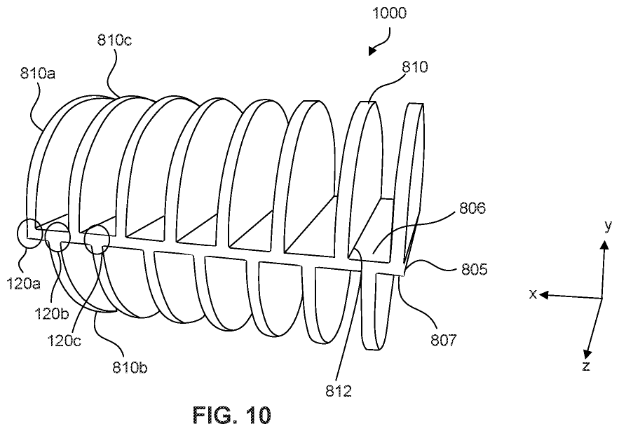

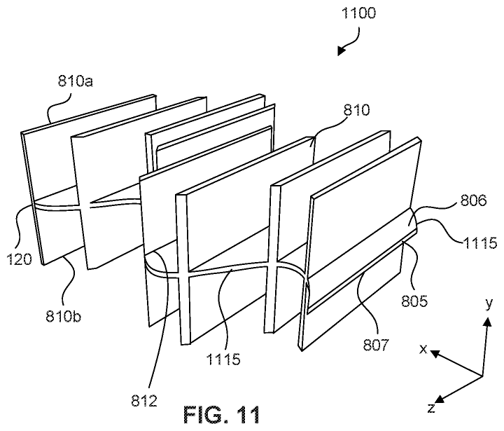

FIG. 10 is an illustration of a starch-based extruded food product 1000 according to another embodiment. In embodiments according to FIG. 10, fin bodies 810 (such as 810a, 810b, and 810c) may extend from a top surface 806 and a bottom surface 807 of base body 805 and are coupled to base body 805 at different joints 120 (such as joints 120a, 120b, and 120c). That is, the fin bodies 810 extending from the top surface 806 may be offset longitudinally (e.g., along the x-axis) from the fin bodies 810 extending from the bottom surface 807. In some embodiments, all fin bodies 810 may be offset, whereas in some embodiments only some fin bodies 810 may be offset and others may be aligned. Again, the joints 120 are the intersection of the edge 812 in the x-z plane of fin bodies 810 and the bottom surface 807 or top surface 806, respectively, of base body 805. The joints 120 are more particularly indicated by the circles depicted at the end of the lead lines in the figure. As shown, the joints 120 represent areas or regions where two or more bodies come together. The base body 805 runs the length of the starch-based extruded food product 100 in the longitudinal axis. The top surface 806 and bottom surface 807 are opposing sides of the base body 805 that are in the x-z plane. In some embodiments, the fins 810 extend from the edge 812 that is coupled to the base body 805 at a joint 120. In some additional embodiments, the fin bodies 810 extending from the top surface 806 may be substantially coplanar with the fin bodies extending from the bottom surface 807. In some other embodiments, the fin bodies 810 extending from the top surface 807 may be substantially in offset non-coplanar alignment with the fin bodies 810 extending from the bottom surface 807.

In some embodiments, the fin bodies 810 may extend from base body 805 so as to be on alternating sides in the longitudinal direction. In other words, the joints 120 for each fin body 810 may be located along the base body 805 such that, as viewed from the y-z plane, each joint 120 has a fin body 810 that extends from the opposing surface as the fin bodies 810 and joints 120 to either side of it in the longitudinal direction.

For example, joints 120a, 120b, and 120c may be dispersed or located longitudinally along the base body 805 with joint 120b located between joints 120a and 120c. Fin bodies 810a and 810c extend from the top surface 806 on one side of base body 805, while fin body 810b extends from the bottom surface 807 on the opposite side of base body 805. Other embodiments of the starch-based extruded food product 000 may have fin bodies 810 coupled to base body 805 with other patterns of joints, such as consecutive fin bodies 810 extending from the top surface 806 of the base body 805 and then consecutive fin bodies 810 extending from the bottom surface 807 of the base body 805.

FIG. 11 illustrates a starch-based extruded food product 1100 according to at least some embodiments. In such embodiments, the starch-based extruded food product 1100 is a rigid extruded body with a base body 805 coupled to fin bodies 810 (such as 810a and 810b) at joints 120. The joints 120 are the intersection of the edge 812 in the x-z plane of fin bodies 810 and the bottom surface 807 or top surface 806, respectively, of base body 805. The base body 805 runs the length of the starch-based extruded food product 1100 in the longitudinal axis. The top surface 806 and bottom surface 807 are opposing sides of the base body 805 that are in the x-z plane.

In some embodiments, the edges of base body 805 which run in the longitudinal direction are curved edges 1115 when viewed along a vertical direction (the y-axis or in the x-z plane). In some embodiments, the edges are sinusoidal, substantially sinusoidal, curved, or zig-zag. The vertical edges of the fin bodies 810 vary in shape to match the curved edges 1115 of the base body 805.

For example, in embodiments according to FIG. 11, starch-based extruded food product 1100 has fin bodies 810a and 810b coupled to base body 805 at joint 120. The curved edges 1115 of base body 805, when viewed from a vertical axis, may be substantially sinusoidal in the longitudinal. The vertical edges of fin bodies 810 may also be shaped to match this curve.

In some embodiments, the fins 810 extend from the edge 812 that is coupled to the base body 805 at a joint 120. In some additional embodiments, the fin bodies 810 extending from the top surface 806 may be substantially coplanar with the fin bodies extending from the bottom surface 807. In some other embodiments, the fin bodies 810 extending from the top surface 807 may be substantially in offset non-coplanar alignment with the fin bodies 810 extending from the bottom surface 807.

In some embodiments, the joints 120 where fin bodies 810 couple to the base body 805 may be evenly spaced on the base body 805 along the longitudinal axis. In some other embodiments, the joints 120 where fin bodies 810 couple to the base body 805 may be un-evenly spaced on the base body 805 along the longitudinal axis.

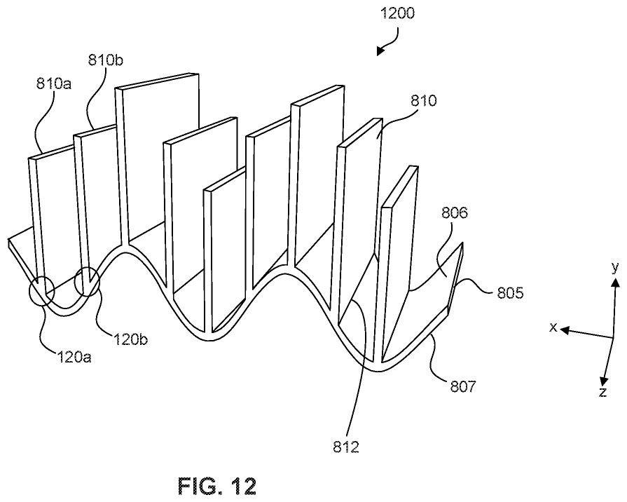

FIG. 12 illustrates a starch-based extruded food product 1200 according to at least some embodiments. In such embodiments, starch-based extruded food product 1200 is a rigid extruded body with a base body 805 coupled to fin bodies 810 (such as 810a and 810b) at joints 120 (such as 120a and 120b). The joints 120 may be the intersection of the edges 812 of the fin bodies 810 and the top surface 806 of base body 805. The joints 120 are more particularly indicated by the circles depicted at the end of the lead lines in the figure. As shown, the joints 120 represent areas or regions where two or more bodies come together. The base body 805 runs the length of the starch-based extruded food product 1200 in the longitudinal axis. The top surface 806 and bottom surface 807 are opposing sides of the base body 805 that are in the x-z plane.

Base body 805 may be shaped such that the top surface 806 and bottom surface 807 of base body 805 are not flat. For example, the top surface 806 and bottom surface 807 of base body 805 may be angled, bent, or curved. In a specific embodiment, as depicted in FIG. 12, base body 805 has a sinusoidal or near-sinusoidal shape with fin bodies 810a and 810b, coupled to base body 805 at joints 120a and 120b respectively. In some embodiments, such as the one depicted in FIG. 12, fin bodies 810 are similar in size or substantially the same size, resulting in the top horizontal edges of the fin bodies 810 mirroring the shape of the top surface 806 of the base body 805. In some embodiments, the fin bodies 810 are sized such that the top horizontal edges of the fin bodies 810 form a different shape than the top surface 806 of the base body 805. In some embodiments, the different shape is flat or curved.

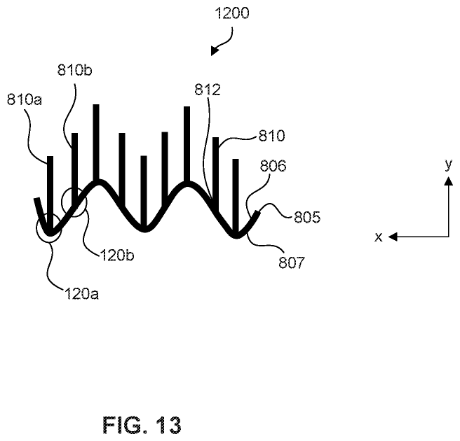

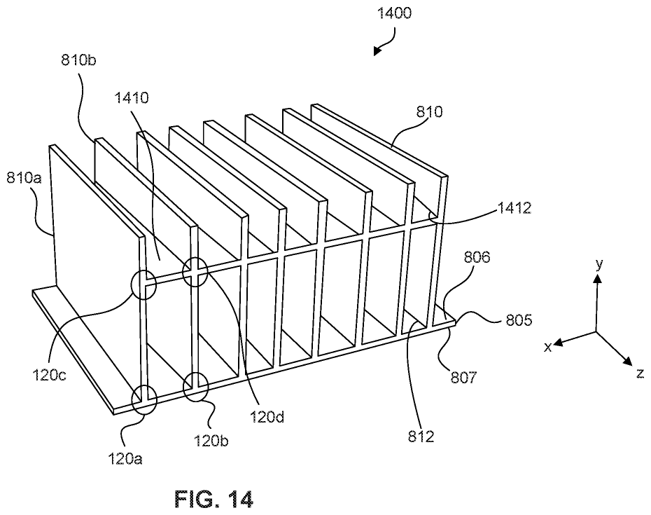

FIG. 13 is a side view of a starch-based extruded food product such as the starch-based extruded food product 1200 according to the embodiment depicted in FIG. 12. In some embodiments, base body 805 may be coupled to fin bodies 810a and 810b at joints 120a and 120b respectively along edges 812 of the bodies 810. The joints 120 are more particularly indicated by the circles depicted at the end of the lead lines in the figure. As shown, the joints 120 represent areas or regions where two or more bodies come together.

FIG. 14 illustrates a starch-based extruded food product 1400 according to at least some embodiments. Starch-based extruded food product 1400 is a rigid extruded body with a base body 805 coupled to fin bodies 810 at joints 120 on the top surface 806 of base body 805, such as fin bodies 810a and 810b coupled at joints 120a and 120b respectively. The joints 120a and 120b are the intersection of fin bodies 810 and the base body 805 at a top surface 806 along the edges 812 of the fin bodies 810. The base body 805 runs the length of the starch-based extruded food product 1400 in the longitudinal axis. The top surface 806 and bottom surface 807 are opposing sides of the base body 805 that are in the x-z plane.

As shown in FIG. 14, a support body 1410 may be coupled to fin bodies 810a and 810b at joints 120c and 120d, respectively. This support body 1410 is offset from top surface 806 of the base body 805 in the vertical direction. The support body 1410 may provide additional structural stability to the bodies of the starch-based extruded food product 100. The joints 120c and 120d are the intersection of the edges 1412 of the support body 1410 with the y-z surface of the fin bodies 810. The joints 120 are more particularly indicated as described above with regards to FIG. 14 and as indicated by the circles depicted at the end of the lead lines in the figure. As shown, the joints 120 represent areas or regions where two or more bodies come together.

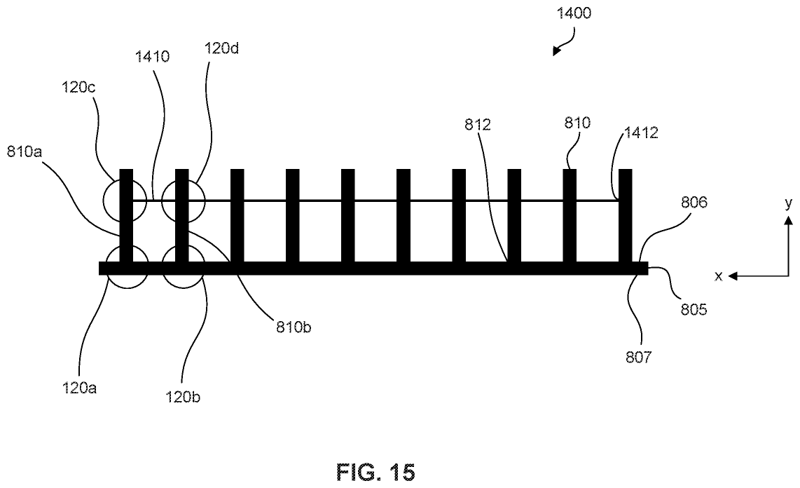

FIG. 15 is a side view of a starch-based extruded food product such as the starch-based extruded food product 1400 according to the embodiment depicted in FIG. 14. As before, base body 805 is coupled to fin bodies 810a and 810b at joints 120a and 120b respectively, with support body 1410 coupled to fin bodies 810a and 810b at joints 120c and 120d, respectively. The joints 120 are more particularly indicated as described above with regards to FIG. 14 and as indicated by the circles depicted at the end of the lead lines in the figure. As shown, the joints 120 represent areas or regions where two or more bodies come together, such as where edges 1412 of the support bodies 1410 meet the fin bodies 810.

In some embodiments of the starch-based extruded food product, fin bodies 810 may be semi-circular, semi-elliptical, or rounded in shape when viewed from the y-z plane down the longitudinal axis, such as the fin bodies 810 depicted in FIG. 8 or FIG. 10. In other embodiments, fin bodies 810 may be rectangular or square, such as the fin bodies 810 depicted in FIG. 9 or FIGS. 11-15. Still other embodiments may have fin bodies 810 with other polygonal or irregular shapes, and the shapes depicted in the figures and described herein should not be seen as limiting. In some embodiments, fin bodies 810 extending from different surfaces may have different shapes.

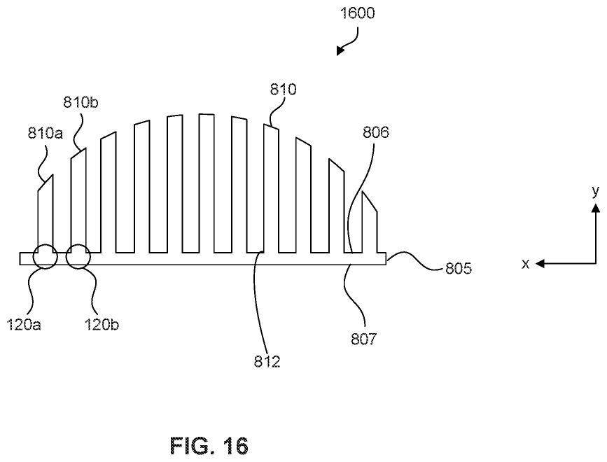

FIG. 16 illustrates a starch-based extruded food product 1600 according to at least some embodiments. In such embodiments, fin bodies 810 coupled to base body 805 at joints 120, such as fin bodies 810a and 810b coupled to base body 805 at joints 120a and 120b. Base body 805 has a top surface 806 and a bottom surface 807. The joints 120a and 120b are the intersection the edges 812 of the fin bodies 810a and 810b and the top surface 806. The joints 120 are more particularly indicated by the circles depicted at the end of the lead lines in the figure. As shown, the joints 120 represent areas or regions where two or more bodies come together. In some embodiments, fin bodies 810 may be different sizes such that the top edges of fin bodies 810 form a shape along the longitudinal axis when viewed in the x-y plane. In some embodiments, the shape may be a tapered or curved shaped.

In various embodiments of starch-based extruded food products as described above, the shape of the bodies may be complementary such that a first starch-based extruded food product may nest within a second starch-based extruded food product. For example, the starch-based extruded food products 400 depicted in FIG. 4 may be configured such that if a first starch-based extruded food product 400 is inverted, it can rest on a second starch-based extruded food product 400 with the various shapes 430 interlocked or conformably stacked. In some embodiments, this interlocking may allow for higher density packing of the starch-based extruded food products. In some embodiments, this may allow multiple starch-based extruded food products to be packaged in the same package, therefore using less packaging volume than would be required for the multiple starch-based extruded food products individually. Those skilled in the art will appreciate that the various embodiments may have bodies 110, shapes 430, and/or fin bodies 810 that are configured to be conformably stacked. In some embodiments, stacking conformably may require inversion of the starch-based extruded food products or repositioning of the starch-based extruded food products relative to one another (e.g., shifted off-center) along an axis or direction, such as the longitudinal axis. In some embodiments, packaging of the starch-based extruded food products may be in form-fill packaging as described elsewhere herein and the packaging may be further designed such that the packaged starch-based extruded food products may be stacked in a similar manner to the unpackaged starch-based extruded food products. In some embodiments, the stacking may depend on the shape of the starch-based extruded food products. In some embodiments, the stacking may depend on the shape of the form-fill packaging. In some embodiments, the conformal stacking may allow the starch-based food products to be stacked for shipping with a reduced volume. In some embodiments, conformal stacking may reduce breakage of or damage to the starch-based extruded food products during shipping.

In some embodiments, the starch-based extruded food products may have bodies 110, shapes 430, and/or fin bodies 810 which are shaped such that, when broken apart as described above, the bodies 110, shapes 430, and/or fin bodies 810 have a scoop shape. For example, in some embodiments, the bodies 110 may be shaped to be scoops suitable for dipping in another food product, such as a sauce or salsa. In some embodiments, two or more bodies 110 may be broken off of a starch-based extruded food product to be a scoop.

FIG. 17 is a flow chart of a method 1700 for manufacturing a cooked starch-based extruded food product, such as the starch-based extruded food product 100 described above, or other embodiments thereof. Method 1700 includes one or more operations, functions, steps or actions as illustrated by one or more of steps 1710, 1720, 1730, and 1740. Such operations, functions, or actions in FIG. 17 and in the other figures, in some embodiments, may be combined, eliminated, modified, and/or supplemented with other operations, functions or actions, and need not necessarily be performed in the exact sequence as shown. The operations described in the steps 1710-1740 may be implemented with a series of devices and/or systems, for example, as described below and depicted in FIGS. 19-21.

Method 1700 begins at step 1710, “extruding a starch-based food mixture,” to form an extrusion. Step 1710 is followed by step 1720, “cutting the extrusion,” to form a starch-based extruded food product. Step 1720 is followed by step 1730, “cooking the starch-based extruded food product,” to form a cooked starch-based extruded food product. In some embodiments, manufacturing a cooked starch-based extruded food product may further involve step 1740, “packaging the cooked starch-based extruded food product.”

The process of extruding the starch-based food mixture or dough according to step 1710 may result in a variety of embodiments of the extrusion. In some embodiments, the extrusion is shaped according to one of the starch-based extruded food products 100 depicted in FIGS. 1 to 16. Step 1710 may be performed by an extruder device or system, which may be implemented under operational control by a controller as described herein.

In some embodiments, the starch-based food mixture is derived from tubers. In some embodiments, the starch-based food mixture is a combination of a variety of starches, such as corn, potato, or wheat. In some embodiments, the starch-based food mixture contains one or more of rice flour, wheat flour, potato flakes, or gluten. In some embodiments, the starch-based food mixture has flavoring added. In some embodiments, the starch-based food mixture has additives or supplements that increase the nutritional value of the food mixture. In some embodiments, the starch-based food mixture contains salt, water, or both.

At step 1720, the extrusion is cut to separate sections of the extrusion into pieces such as the starch-based extruded food product 100 depicted in FIGS. 1 to 16. In some embodiments, the extrusion is cut along a straight edge or line. In some embodiments, cutting the extrusion involves cutting a shaped edge, such as the curved edge depicted on the starch-based extruded food product 100 in FIG. 11. Step 1720 may be performed by a cutting device or system, which may be implemented under operational control by a controller as will be described later herein.

In some embodiments, cutting the extrusion is a multi-step process. For example, in some embodiments, the pieces are first cut from the extrusion as described above. The pieces of the extrusion are then cut to form different shapes, such as cutting the fin bodies 810 to a curved shape as depicted in FIG. 8. In some embodiments, cutting the pieces and cutting the fin bodies or other bodies is accomplished in a single step. In some embodiments, cutting includes abrading, cutting, perforating, or raking the starch-based extruded food products to produce features at the joints that aid in breaking apart bodies of the starch-base extruded food products.

At step 1730, the starch-based extruded food product may be cooked by a variety of cooking methods and devices, including, for example, frying, boiling, broiling, grilling, poaching, steaming, freeze-drying, baking, or microwaving. Step 1730 may be performed by a cooking device or system, which may be implemented under operational control by a controller as will be described later herein.

In some embodiments, cooking the starch-based extruded food product is a multi-step process, such as method 1730 described in FIG. 18 below. In some embodiments, the multi-step process may involve freeze-drying the starch-based extruded food product prior to cooking. In some embodiments, the cooking is a multi-step process, such as baking or microwaving the starch-based extruded food product before or after frying it. In some embodiments, the starch-based extruded food product is coated in oil or immersed in water prior baking or frying. In some embodiments, flavoring is added or applied to the starch-based extruded food product as part of the cooking process.

At step 1740, the cooked starch-based extruded food product may be packaged using a variety of standard packaging techniques and packaging types. Step 1740 may be performed by a packaging device or system, which may be implemented under operational control by a controller as will be described later herein.

In some embodiments, the packaging is a form-fill packaging. In some embodiments, the form-fill packaging is flush to the shape of the cooked starch-based extruded food product. In some embodiments, the shape of the cooked starch-based extruded food product and the form-fill packaging is selected to maximize cargo density for shipping when the packaged cooked starch-based extruded food products are stacked or otherwise arranged for shipping.

The operations included in the above-described process are for illustration purposes. The operations described herein may be executed under control by various controller circuits, devices, or processors; including but not limited to, a digital controller that is capable of executing instructions such as one or more processors operated on one or more computing devices, one or more processor cores, and/or specialized processing devices, circuits or controller devices.

FIG. 18 is a flow chart of the method 1730 for cooking the starch-based extruded food product according to at least some embodiments. Method 1730 includes one or more operations, functions, steps or actions as illustrated by one or more of steps 1731, 1732, 1733, and 1734. Such operations, functions, or actions in FIG. 18 and in the other figures, in some embodiments, may be combined, eliminated, modified, and/or supplemented with other operations, functions or actions, and need not necessarily be performed in the exact sequence as shown. The operations described in the steps 1731-1734 may be implemented with a series of devices and/or systems as will be depicted later with respect to FIGS. 19-21.

The embodiments of method 1730 involve step 1731, “coating the starch-based extruded food product in oil.” Step 1731 is followed by step 1732, “baking the starch-based extruded food product.” Step 1732 is followed by step 1733, “dipping the starch-based extruded food product in water.” Step 1733 is followed by step 1734, “frying the starch-based extruded food product.” In some embodiments, these steps are performed in an ordered sequence as depicted in the flow chart. In other embodiments, such steps need not necessarily be performed in the exact sequence as shown.

At step 1731, the starch-based extruded food product may be coated in oil by, for example, dipping, coating, or spraying the starch-based extruded food product in room-temperature oil prior to baking. Step 1731 may be performed, for example, by an immersion system, a sprayer, or other device for coating food products with oil, which may be implemented under operational control by a controller as will be described later herein.

At step 1732 the starch-based extruded food product may be baked at a temperature of about 315 degrees Fahrenheit. In some embodiments, the baking occurs at a temperature of about 400 degrees Fahrenheit. In some embodiments, baking occurs at a temperature from about 310 degrees Fahrenheit to about 320 degrees Fahrenheit. In some embodiments, baking occurs at temperatures from about 300 degrees Fahrenheit to about 330 degrees Fahrenheit.

In some embodiments, the baking occurs for about ninety seconds. In some embodiments, baking occurs from about eighty-five seconds to about ninety-five seconds. In some embodiments, baking occurs from about one minute to about two minutes.

In some embodiments, the baking process of step 1732 is chosen as part of method 1730 to reduce, for example, bubbling, greasiness, messiness, and/or loudness of the cooked starch-based extruded food products.

Step 1732 may be performed by an oven, microwave, or other cooking vessel, which may be implemented under operational control by a controller as will be described later herein.

At step 1733, the starch-based extruded food product may be dipped in water prior to frying. In some embodiments, step 1733 is performed after baking and before frying. In some embodiments, the starch-based extruded food product is dipped in water. In some embodiments, the dipping involves immersing the starch-based extruded food product in water for less than about five seconds. Step 1733 may be performed by an immersion system, a sprayer, or other device for coating food products with water, which may be implemented under operational control by a controller as will be described later herein.

At step 1734, the starch-based extruded food product may be fried at about 325 degrees Fahrenheit. In some embodiments, frying occurs at about 390 degrees Fahrenheit. In some embodiments, frying occurs from about 320 degrees Fahrenheit to about 330 degrees Fahrenheit. In some embodiments, frying occurs from about 300 degrees Fahrenheit to about 350 degrees Fahrenheit.

In some embodiments, frying occurs from about twenty-five seconds to about four minutes and fifteen seconds. In some embodiments, frying occurs from about two to about three minutes.

In some embodiments, the frying process of step 1734 is chosen as part of method 1730 to reduce, for example, bubbling, greasiness, messiness, and/or loudness of the cooked starch-based extruded food products.

Step 1734 may be performed by a fryer or other cooking vessel, which may be implemented under operational control by a controller as will be described later herein.

FIG. 19 is an embodiment of a system for performing the method of FIG. 17. In the manufacturing system 1900, a starch-based food mixture 1905 in an extruder feeder 1910 is fed into an extruder 1920. The extruder 1920 extrudes the starch-based food mixture into an extruder output 1925, which leads to a cutter 1930, which cuts the starch-based food mixture into starch-based extruded food products. The starch-based extruded food product goes to a cooking input 1935 and is fed into the cooking system 1940, which cooks the starch-based extruded food product and passes it on to the cooking output 1945. The cooking output 1945 passes the cooked starch-based extruded food product to the packaging machine 1950, which packages the cooked starch-based extruded food product.

In some embodiments, the manufacturing system 1900 is an automated manufacturing line. The automation may be operated under supervision of one or more controller devices or systems. For example, a controller 1960 can be coupled to devices as illustrated. The controller 1960 may be implemented as a single controller device, or a plurality of controller devices at each machine, each commonly operated under control by a master controller device. The controller devices may be implemented as electronic circuits, or computer devices operated under machine executable instruction configured to perform steps of methods as described above, to provide operational control of devices described herein, or to perform overall control of the various systems described herein. In some embodiments, the machine executable instructions may be stored on a non-transitory computer readable medium. Various aspects of the controllers, their operation, and the type of instructions they execute in the description below.

While controllers 1960 are depicted as located in some of the devices or systems described in the manufacturing system 1900, other controllers may be located in the manufacturing system 1900 as needed for specific implementations. In some embodiments, one or more of the controllers 1960 may operate in a network or other cooperative system. In some embodiments, a single controller 1960 may operate the entire manufacturing system 1900 and be connected, wired or wirelessly, to the various devices and systems that make up the manufacturing system 1900.

In some embodiments, the extruder feeder 1910 conveyor belt, pipe, or other device that supplies the extruder 1920 with the starch-based food mixture 1905. In some embodiments, the extruder feeder 1910 is a container or storage area that is integral or directly connected to the extruder 1920. In some embodiments, a speed or other operational parameters necessary to operate the extruder feeder 1910 may be operated under control/monitoring by a controller 1960.

In some embodiments, the extruder 1920 is a device or system that extrudes dough or other malleable or extrudable materials, such as the starch-based food mixture 1905. A speed or other operational parameters necessary to operate the extruder 1920 may be operated under control/monitoring by a controller 1960.

In some embodiments, the extruder output 1925 is a conveyor belt or feed system that supplies the cutter 1930. In some embodiments, the extruder output 1925 is direct output of the extruder 1920. In some embodiments, extruder 1920 has a shaped output. In some embodiments, the shaped output is shaped such that, when cut by cutter 1930, the extruded starch-based food mixture 1905 is a starch-based extruded food product. A speed or other operational parameters necessary to operate the extruder output 1925 may be operated under control/monitoring by a controller 1960.

In some embodiments, the cutter 1930 is a separate cutting system that receives the extruded starch-based food mixture from the extruder output 1925. In some embodiments, the cutter 1930 is attached to or part of the extruder 1920 such that the extruded starch-based food mixture exits the extruder 1920 at the extruder output 1925 and is cut at the extruder output 1925 by the cutter 1930. A speed or other operational parameters necessary to operate the cutter 1930 may be operated under control/monitoring by a controller 1960. In some embodiments, the controller 1960 controls the direction in which the cutter 1930 cuts the extruded starch-based food mixture.

In some embodiments, the cutter 1930 cuts the extrusion in more than one direction, such as making a first cut to cut the extrusion into pieces as it is extruded from the extruder 1920 at the extruder output 1925 and then cutting orthogonally to the first cut. In some embodiments, this second cut is made to cut a shape into the fin bodies 810 of a starch-based extruded food product 100 as described above.

In some embodiments, the cooking input 1935 is a conveyor belt or other system for conveying the cut extruded starch-based food product from the cutter 1930 to the cooking system 1940. A speed or other operational parameters necessary to operate the cooking input 1935 may be operated under control/monitoring by a controller 1960. In some embodiments, cooking system 1940 is one or more of an oven, a fryer (e.g., a deep fryer), a freeze-dryer, a microwave, or another device for cooking food products. In some embodiments, the oven or fryer is an automated system with a conveyor belt for feeding food products through the oven or fryer.

In some embodiments, cooking system 1940 has a temperature control for adjusting the temperature at which a given cooking process takes place. In some embodiments, cooking system 1940 has a timer for controlling the length of time food is cooked. In some embodiments, cooking system 1940 includes a conveyor system for moving food products through the cooking system 1940 as they are cooked. In some embodiments, cooking system 1940 includes one or more cooling or waiting areas for cooling or otherwise reducing the temperature of the food products before they are passed to other devices in the cooking system 1940 or to cooking output 1945. One or more controllers 1960 may be present to operate or control various operation parameters, such as speed, time of operation, temperature, or other operational parameters, for the various devices and systems that make up the cooking system 1940 in various embodiments.

In some embodiments, cooking system 1940 includes a water immersion system, an oil coating system, or other systems for treating food products.

In some embodiments, the water immersion system is a portion of a conveyor system that lowers into a water vessel to immerse food products on the portion of the conveyor system. In some embodiments, the water immersion system includes a device for restraining food products as they are immersed. In some embodiments, the water immersion system includes a timer for controlling the length of time that food products are immersed in water.

In some embodiments, the oil coating system is a sprayer that sprays oil on food products. In some embodiments, the oil coating system has a controller for controlling the amount of oil disposed on the food products. In some embodiments, the sprayer is positioned over a conveyor belt in the cooking system 1940 to spray food products located on the conveyor belt.

In some embodiments, cooking output 1945 is a conveyor belt or feed system for passing cooked food products from the cooking system 1940 to the packaging machine 1950. A speed or other operational parameters necessary to operate the cooking output 1945 may be operated under control/monitoring by a controller 1960.

In some embodiments, the packaging machine 1950 is an automated form-fill packaging machine which receives food products from the cooking output and packages them in form-fill packaging. In some embodiments, the packaging machine 1950 further packages the food products in form-fill packaging into shipping containers, such as boxes or shipping crates. A speed or other operational parameters necessary to operate the packaging machine 1950 may be operated under control/monitoring by a controller 1960.

FIG. 20 is an embodiment of part of the system in FIG. 19 that is configured to perform the method of FIG. 18. Specifically, FIG. 20 depicts an embodiment of the cooking system 1940.

In some embodiments, cooking system 1940 receives as at its input from the cooking input 1935 a starch-based extruded food product 100. Starch-based extruded food product 100 is representative of any embodiment of a starch-based extruded food product according to the embodiments and variations disclosed herein. The starch-based extruded food product 100 enters the cooking system 1940 and passes into an oil coating system 2010. The starch-based extruded food product 100 then passes out of the oil coating system 2010 onto and along a conveyor belt 2015 into an oven 2020. The starch-based extruded food product 100 then passes out of the oven 2020 onto another conveyor belt 2025 and into a water immersion system 2030. The starch-based extruded food product 100 then passes along a conveyor belt 2035 into a fryer 2040 and then exits the cooking system 1940 onto a cooking output 1945.

Various aspects of the cooking system 1940 may be operated under supervision of one or more controller devices or systems, as described above and as more particularly described below. For example, as single controller 1960 can be coupled to devices as illustrated. The controller 1960 may be implemented as a single controller device, or a plurality of controller devices at each machine, each commonly operated under control by a master controller device. The controller devices may be implemented as electronic circuits, or computer devices operated under machine executable instruction configured to perform steps of methods as described above, to provide operational control of devices described herein, or to perform overall control of the various systems described herein. In some embodiments, the machine executable instructions may be stored on a non-transitory computer readable medium. Various aspects of the controllers, their operation, and the type of instructions they execute in the description below.

While controllers 1960 are depicted as located in some of the devices or systems described in the cooking system 1940, other controllers may be located as needed for specific implementations. In some embodiments, one or more of the controllers 1960 may operate in a network or other cooperative system. In some embodiments, a single controller 1960 may operate the entire cooking system 1940 and be connected, wired or wirelessly, to the various devices and systems that make up the manufacturing system 1900.

In some embodiments, the devices of cooking system 1940 all have conveyor belts to convey starch-based extruded food products 100 through the cooking system and each part of it. In some embodiments, conveyor belts are only used to pass starch-based extruded food products 100 between the devices. In some embodiments, conveyor belts 2015, 2025, and 2035 are part of a single conveyor belt system that is used to move the starch-based extruded food product 100 through the cooking system 1940. In some embodiments, conveyor belts 2015, 2025, and 2035 are separate conveyor belt systems that are used to pass the starch-based extruded food products 100 between devices in the cooking system 1940.

The oil coating system 2010 is a system for coating the starch-based extruded food product 100 with oil. In some embodiments, the oil coating system 2010 has a controller to control how much oil is disposed on a starch-based extruded food product 100 as it passes through the oil coating system 2010. In some embodiments, the oil coating system 2010 has a controller for adjusting the temperature through a heating/cooling system, of the oil that is applied to the starch-based extruded food product 100 as it passes through the oil coating system 2010. In some embodiments, the oil coating system 2010 has a spraying system for spraying the oil on the starch-based extruded food products passing through the oil coating system 2010.

The oven 2020 is used to bake the starch-based extruded food product 100. In some embodiments, the oven 2020 has a controller to control the temperature inside the oven 2020. In some embodiments, the oven 2020 has a controller that controls the time that the starch-based extruded food products are in the oven 2020. In some embodiments, the oven 2020 is a conveyor belt oven and the time that the starch-based extruded food products 100 are in the oven 2020 is controlled by a speed setting of the conveyor belt.

The water immersion system 2030 is used to immerse the starch-based extruded food products 100 in water. In some embodiments, the water immersion system 2030 has a controller to control the amount of time that starch-based extruded food products are immersed in water. In some embodiments, the water immersion system 2030 has a controller that controls the temperature of the water the water in the water immersion system 2030 through a heating/cooling system. In some embodiments, the water immersion system 2030 has a conveyor belt section, basket, or other container or platform that lowers the starch-based extruded food products 100 into the water. In some embodiments, the water immersion system 2030 also has a lid, basket, or cover that helps hold the starch-based extruded food products 100 in place while they are immersed in the water. In some embodiments, the water immersion system 2030 lifts the starch-based extruded food products 100 out of the water using the conveyor belt section, the basket, the other container, a scoop, or pick-and-place type machine.

In some embodiments, the water immersion system 2030 uses a conveyor belt to move the starch-based extruded food products 100 into the water by dropping them off a ledge or conveying them down a sloped or inclined conveyor belt. In some embodiments, the water immersion system 2030 uses a conveyor belt to remove the starch-based extruded food products 100 out of the water by conveying them up a sloped or inclined conveyor belt.

The fryer 2040 is used to fry the starch-based extruded food products. In some embodiments, the fryer 2040 has a controller for controlling the amount of time that the starch-based extruded food products 100 are fried in the fryer 2040. In some embodiments, the fryer 2040 has a controller and a heating/cooling system for controlling the temperature of the oil in the fryer 2040. In some embodiments, the fryer 2040 has a conveyor system to move starch-based extruded food products 100 into the oil of and out again after frying.

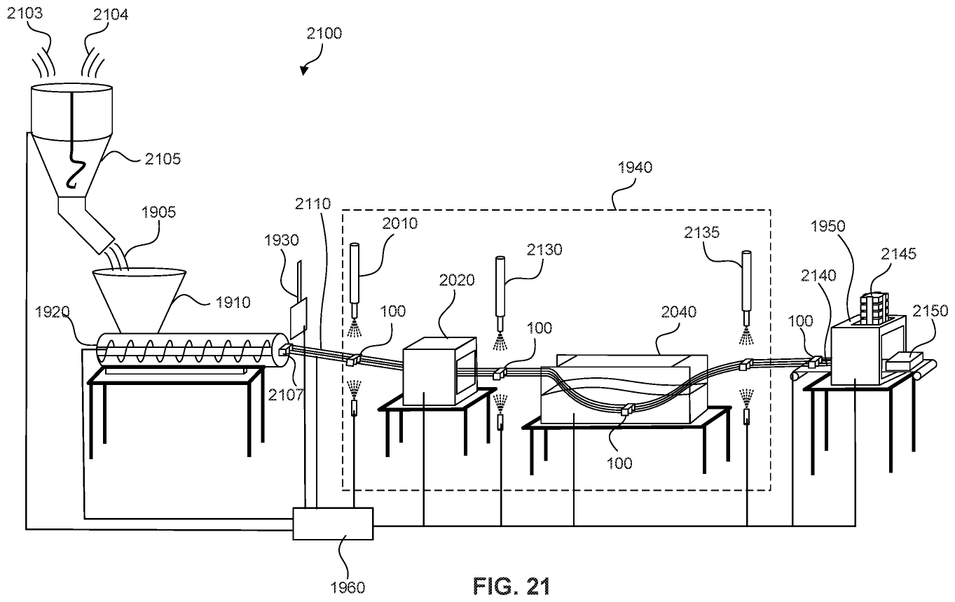

FIG. 21 depicts an embodiment of a manufacturing system 2100 for manufacturing starch-based extruded food products 100. Starch-based extruded food product 100 is representative of any embodiment of a starch-based extruded food product according to the embodiments and variations disclosed herein. In manufacturing system 2100, dry ingredients 2103 and wet ingredients 2104 are combined in dough mixer 2105, which mixes them into starch-based food mixture 1905. Starch-based food mixture 1905 exits the dough mixer 2105 and is stored in or transported along an extruder feeder 1910, which feeds the starch-based food mixture 1905 into the extruder 1920. The extruder 1920 extrudes the mixture onto a rail system 2110 and the extrusion 2107 is cut into starch-based extruded food products 100 by cutter 1930. The starch-based extruded food products 100 move along the rail system 2110 through a cooking system 1940. In the cooking system 1940, the starch-based extruded food product 100 is transported by the rail system 2100 through an oil coating system 2010 which coats the starch-based extruded food product 100 with oil, into and through an oven 2020 which bakes the starch-based extruded food product 100, through a water sprayer 2130 which sprays water on the starch-based extruded food product 100, and into and through a fryer 2040 which fries the starch-based extruded food products. In some embodiments, the cooking system 1940 may include a flavoring sprayer 2135 for applying flavoring (e.g., a liquid or powder flavoring) to the starch-based extruded food products. After cooking in the cooking system 1940, the rail system 2110 deposits the starch-based extruded food product 100 on a conveyor 2140. The conveyor 2140 then moves the starch-based extruded food product 100 into a packaging machine 1950 which packages the starch-based extruded food product 100 in packing 2145 to create packaged starch-based extruded food product 2150. Finally, the conveyor 2140 moves the packaged starch-based extruded food products 100 out of the packaging machine 1950.

FIG. 21 also depicts a single controller 1960 connected to different devices and systems of the manufacturing system 2100. Various aspects of the manufacturing system 2100 may be operated under supervision of one or more controller devices or system, as described above and as more particularly described below. For example, a controller 1960 can be coupled to each of the devices as illustrated. This coupling may be a direct electrical connection or a wireless connection. The controller 1960 may be implemented as a single controller device, or a plurality of controller devices at each machine, each commonly operated under control by a master controller device. The controller devices may be implemented as electronic circuits, or computer devices operated under machine executable instruction configured to perform steps of methods as described above, to provide operational control of devices described herein, or to perform overall control of the various systems described herein. In some embodiments, the machine executable instructions may be stored on a non-transitory computer readable medium. Various aspects of the controllers, their operation, and the type of instructions they execute in the description below.

While controller 1960 is depicted as a single device, other controllers may be located as needed for specific implementations. In some embodiments, one or more of the controllers 1960 may operate in a network or other cooperative system.

In some embodiments, the dry ingredients 2103 are starches or starch-based, including rice flour, wheat flour, gluten, and potato flakes. In some embodiments, the dry ingredients 2103 include salt, or flavoring. In some embodiments, the flavoring is a snack food or potato chip flavoring, such as salt and vinegar flavoring, sour cream and onion flavoring, or other similar flavorings.

In some embodiments, the wet ingredients 2104 are water or oil.

Dough mixer 2105 is configured to combine or mix dry ingredients 2103 and wet ingredients 2104 into starch-based food mixture 1905. In some embodiments, dough mixer 2105 is directly connected to extruder feeder 1910.

Extruder feeder 1910 is configured to provide starch-based food mixture 1905 to extruder 1920. In some embodiments, the extruder feeder 1910 is a conveyor belt, pipe, or other device that supplies the extruder 1920 with the starch-based food mixture 1905. In some embodiments, the extruder feeder 1910 is a container or storage area that is integral or directly connected to the extruder 1920.

In some embodiments, the extruder 1920 is configured to extrude the starch-based food mixture 1905 as extrusion 2107. In some embodiments, extruder 1920 has a shaped output. The shaped output is shaped such that, when cut by cutter 1930, the extrusion 2107 is cut into a starch-based extruded food product 100, such as those described above and in the figures, or described herein.

Cutter 1930 is configured to cut extrusion 2107 as it exits extruder 1920. In some embodiments, the cutter 1930 cuts the extrusion in more than one direction, such as making a first cut to cut the extrusion into pieces as it is extruded from the extruder 1920 at the extruder output 1925 and then cutting orthogonally to the first cut. In some embodiments, this second cut is made to cut a shape into the fin bodies 810 of a starch-based extruded food product 100 as described above and in the figures.

Extrusion 2107 exits the extruder 1920 and passes through the cutter 1930 on rail system 2110, which transports the extrusion 2107 and starch-based extruded food products 100 through the rest of the manufacturing system to a conveyor 2140 at the output. In some embodiments, the rail system 2110 has rails or supports that are configured to support the starch-based extruded food product 100, such as separating bodies 110, bodies 410, or fin bodies 810 (not labeled or shown in this figure) during cooking in the cooking system 1940. In some embodiments, the rail system 2110 is configured to run at a single speed as determined by the needs of the cooking system 1940. In some embodiments, the rail system 2110 runs at variable speeds as set by a controller. In some embodiments, the rail system 2110 is configured such that different sections of the system may run at different speeds, depending on the processes being performed in those sections.

In some embodiments, rail system 2110 may be configured cut, abrade, perforate, or rake the starch-based extruded food product 100 at joints 120. This cutting, abrasion, perforation, or raking may occur during cutting, prior to cooking, during cooking, or in between the various cooking steps described above and below. This may be accomplished by the presence of blades or similar cutting devices incorporated into the rail system 2110. In some embodiments, these blades or cutting devices are part of the rail system for a portion of its length.

Rail system 2110 is configured to transport the starch-based extruded food product 100 into the cooking system 1940 and through an oil coating system 2010. The oil coating system 2010 is a system that sprays oil to coat the starch-based extruded food product 100. In some embodiments, the oil coating system 2010 has a controller to control how much oil is disposed on a starch-based extruded food product 100 as it passes through the oil coating system 2010. In some embodiments, the oil coating system 2010 has a controller for adjusting the temperature, through a heating/cooling system, of the oil that is applied to the starch-based extruded food product 100 as it passes through the oil coating system 2010.

The rail system 2110 is configured to transport the starch-based extruded food product 100 into an oven. The oven 2020 is illustrated as a cooking vessel configured to bake the starch-based extruded food product 100. In some embodiments, the oven 2020 has a controller to control the temperature (or a set of varied temperatures as may be needed in a particular cooking profile) inside the oven 2020. In some embodiments, the oven 2020 has a controller that controls the time that the starch-based extruded food products are in the oven 2020. In some embodiments, the oven 2020 controls the speed at which the rail system 2110 moves the starch-based extruded food product 100 through the oven 2020.

The rail system 2110 is configured to transport the starch-based extruded food product 100 through a water sprayer 2130. The water sprayer 2130 is configured to coat the starch-based extruded food product 100 in water. In some embodiments, the water sprayer 2130 has a controller to control the amount of time that starch-based extruded food products 100 are sprayed with water. In some embodiments, the water sprayer 2130 has a controller that controls the temperature of the water that is sprayed through a heating/cooling system. In some embodiments, the water sprayer 2130 controls the speed at which the rail system 2110 moves the starch-based extruded food product 100 through the water sprayer 2130.

The rail system 2110 then transports the starch-based extruded food products 100 into the fryer 2040. The fryer 2040 is used to fry the starch-based extruded food products 100. In some embodiments, the fryer 2040 has a controller for controlling the amount of time that the starch-based extruded food products 100 are fried in the fryer 2040. In some embodiments, the fryer 2040 has a controller and a heating/cooling system for controlling the temperature of the oil in the fryer 2040. In some embodiments, the fryer 2040 controls the speed of the rail system 2110 as it moves through the fryer 2040.

In some embodiments, rail system 2110 then transports the starch-based extruded food products through a flavor application system, such as flavoring sprayer 2135. Flavoring sprayer 2135 sprays one or more flavoring (e.g., liquid or powder flavoring) on one or more surfaces of the starch-based extruded food products 100. In some embodiments, the flavoring sprayer 2135 has a controller for controlling various factors of the flavor application, such as the length of time of the spray and the choice of flavoring in the spray. In some embodiments, the controller may also control whether the flavoring spray is a mixture of flavorings and the amount of each flavoring in the mixture. In some embodiments, the flavoring is a snack food or potato chip flavoring, such as salt and vinegar flavoring, sour cream and onion flavoring, or other similar flavorings.

Rail system 2110 is configured to transport the starch-based extruded food products 100 out of the fryer 2040 and deposits them on a conveyor 2140.

Conveyor 2140 is configured to transport the starch-based extruded food products 100 to a packaging machine 1950 which packages the starch-based extruded food products 100 in packaging 2145. The packaged starch-based extruded food products 2150 then exit on the conveyor 2140.

In some embodiments, the packaging machine 1950 is an automated form-fill packaging machine. In some embodiments, the packaging 2145 is form-fill packaging. In some embodiments, the form-fill packaging is shaped to match the starch-based extruded food products 100.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims. It is to be understood that the phraseology or terminology herein is for the purpose of description and not of limitation, such that the terminology or phraseology of the present specification is to be interpreted by those skilled in relevant art(s) in light of the teachings herein.

The above examples are illustrative, but not limiting, of the embodiments of this disclosure Other suitable modifications and adaptations of the variety of conditions and parameters normally encountered in the field, and which would be apparent to those skilled in the relevant art(s), are within the spirit and scope of the disclosure.

While specific embodiments of the disclosure have been described above, it will be appreciated that the disclosure may be practiced otherwise than as described. The descriptions above are intended to be illustrative, not limiting. Thus it will be apparent to one skilled in the art that modifications may be made to the disclosure as described without departing from the scope of the claims set out below.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1.-44. (canceled)

45. A starch-based extruded food product that comprises a rigid extruded body made of a starch-based material, the rigid extruded body comprising:
a plurality of bodies that include a base body with a top surface and a bottom surface opposite the top surface, and a first fin body that extends from the top surface and that, when viewed along a longitudinal axis, has a cross-sectional shape that corresponds to one of a circle, a semi-circle, an ellipse, a semi-ellipse, or a polygon; and
a joint;
wherein at least one of the plurality of bodies is coupled to at least another of the plurality of bodies at the joint and the fin body is coupled to the top surface of the base body at the joint.

46. The starch-based extruded food product of claim 45, wherein the plurality of bodies comprises a first body, a second body, and a third body, wherein the first body is coupled to the second body at a first joint, the second body is coupled to the third body at a second joint, and the second body is disposed between the first body and the third body.

47. The starch-based extruded food product of claim 45, wherein the plurality of bodies each define a shape with an interior portion that defines an aperture and an exterior portion that is coupled to another of the plurality of bodies.

48. The starch-based food product of claim 45, wherein the plurality of bodies further comprises a second fin body, wherein a support body offset from the base body is coupled to the first fin body at a first fin joint and also coupled to the second fin body at a second fin joint.

49. The starch-based extruded food product of claim 45, wherein the plurality of bodies further comprises a second fin body that extends from the bottom surface and is coupled to bottom surface of the base body at the joint.

50. The starch-based extruded food product of claim 45, wherein the plurality of bodies further comprises a second fin body that extends from the bottom surface and a third fin body extends from the top surface, wherein the second fin body is coupled to the bottom surface of the base body at a second joint, the third fin body is coupled to the top surface of the base body at a third joint, and the second joint is located between the joint and the third joint along a longitudinal axis of the base body.

51. The starch-based extruded food product of claim 49, wherein the second fin body when viewed along a longitudinal axis has a cross-sectional shape that corresponds to one of: a circle, a semi-circle, an ellipse, a semi-ellipse, or a polygon.

52. The starch-based extruded food product of claim 50, wherein the third fin body when viewed along a longitudinal axis has a cross-sectional shape that corresponds to one of: a circle, a semi-circle, an ellipse, a semi-ellipse, or a polygon.

53. The starch-based extruded food product of claim 45 wherein the rigid extruded body is configured to break at the joint upon application of a force to separate the at least one of the plurality of bodies from the at least another of the plurality of the plurality of bodies.

54. The starch-based extruded food product of claim 53, wherein the at least one of the plurality of bodies is disposed at an oblique angle with respect to the at least another of the plurality of bodies.

55. The starch-based extruded food product of claim 53, wherein:
a first body of the plurality of bodies defines a first shape having an exterior surface and an aperture through the first shape;
the first body is coupled to a second body of the plurality of bodies at the joint; and
the rigid extruded body is further configured to break at the joint upon the application of a first force to separate the first body from the second body.

56. The starch-based extruded food product of claim 55, wherein the second body defines a second shape having a second exterior surface and a second aperture through the second shape, wherein the second shape is the same as the first shape.

57. A method for manufacturing a starch-based extruded food product, comprising the following sequential steps:
extruding a starch-based food mixture to form an extrusion;
cutting the extrusion to form a starch-based extruded food product;
coating the starch-based extruded food product in oil;
baking the coated starch-based extruded food product;
immersing in or spraying with water the baked starch-based extruded food product; and,
frying to obtain a cooked starch-based extruded food product.

58. The method of claim 57, wherein baking is conducted at a temperature from about 310° F. to about 320° F. for a period of time from about 85 seconds to about 95 seconds.

59. The method of claim 57, wherein frying is conducted at a temperature from about 320° F. to about 330° F. for a time in a range of about 2 to about 3 minutes.

60. A system for manufacturing a starch-based extruded food product, the system comprising:
a dough mixer, an extruder feeder, an extruder, a cutter, a rail system, a cooking system, and a conveyor system, wherein:
the dough mixer is configured to combine and mix wet ingredients and dry ingredients into a starch-based food mixture;
the extruder feeder is configured to provide the starch-based food mixture to an extruder;
the extruder is configured to extrude the starch-based food mixture into an extrusion;
the cutter is configured to cut the extrusion into starch-based extruded food products;
the rail system is configured to transport the starch-based extruded food products through the cooking system, the cooking system configured to cook the starch-based extruded food products, and deposit the starch-based extruded food products on the conveyor system.

61. The system of claim 60, further comprising a packaging machine fed by the conveyor system, wherein the packaging machine is configured to package the starch-based extruded food products in a package.

62. The system of claim 61, wherein the cooking system comprises an oven configured to bake the starch-based extruded food products.

63. The system of claim 61, wherein the cooking system comprises a fryer configured to fry the starch-based extruded food products.

64. The system of claim 61, wherein the cooking system comprises:
an oil sprayer configured to spray the starch-based extruded food products with oil;
an oven configured to bake the starch-based extruded food products that have been sprayed with oil;
a water sprayer configured to spray the starch-based extruded food products with water after baking; and
a fryer configured to fry the starch-based extruded food products that have been sprayed with water.
